(19) United States
(12) Patent Application Publication
(10) Pub. No.: US 2005/0285285 A1
(43) Pub. Date: Dec. 29, 2005

(54) Manufacturing method for light guide body

(75) Inventor: Seiichi Watanabe, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/151,433

(22) Filed: Jun. 14, 2005

(30) Foreign Application Priority Data
Jun. 29, 2004 (JP) 2004-191926

(51) Int. Cl. B29D 11/00

(52) U.S. Cl. 264/1.24; 264/2.7; 425/542; 425/556

(57) ABSTRACT

Disclosed is a manufacturing method for a light guide body which can prevent light leakage reliably even when the light guide body is formed by injection molding. The method for manufacturing a light guide body includes the step of forming roughness Ra of a surface of the light guide body to equal to/less than 1.0 μm, and step heights on the surface to equal to/less than 10 μm, by means of injection molding.

### BACKGROUND OF THE INVENTION

1. Field of the Invention

The present invention relates to a manufacturing method for a light guide body for dispersing light sent from a single optical fiber and transmitting the dispersed light to a plurality of optical fibers.

2. Description of the Related Art

In recent years, optical sheet buses for, for example, dispersing light sent from a single optical fiber and transmitting the dispersed light to a plurality of optical fibers have developed as buses for optical communications. A typical example of such an optical sheet bus is one which has a rectangular sheet-shape and which is made of material such as Polymethyl methacrylate (PMMA) (see Japanese Unexamined Patent Application Publication 11-31035).

In the above conventional technique, there has been a possibility of transmitting light inefficiently due to the fact that the optical sheet bus is rectangular in shape. Concretely, as shown in FIG. 10A, three optical fibers 120, which serve as input terminals, are connected to one end face 110a of an optical sheet bus 110. A single optical fiber 120, which serves as an output terminal, is connected to the other end face 110b. Furthermore, light is made to travel through the optical sheet bus 110, and diffuses toward the other end face 110b side. In this case, light cannot be transmitted efficiently because an only part of light inputted from the single optical fiber enters the three optical fibers 120. On the other hand, the other part is reflected on a wall (see the shaded area of FIG. 10B as viewed from the Z arrow of FIG. 10A) on the other end face 110b side and, then returns to the one end face 110a side.

Additionally, in a case where light is transmitted from the single optical fiber 120 on the other end face 110b side to the three optical fibers 120 on the one end face 110a side as shown in FIG. 10C, a part of light is reflected on a wall of the one end face 110a similarly.

In a manufacturing method for such an optical sheet bus, injection molding has been proposed.

When an optical sheet bus is manufactured by injection molding, however, there is a problem that light leaks from an optical sheet bus. It should be noted that it has been proven through keen research by the inventors that this problem is attributable to the fact that step heights and large roughness are formed on the surface of an optical sheet bus in the course of injection molding.

Therefore, an object of the present invention is to provide a manufacturing method for a light guide body capable of preventing light leakage reliably even when the light guide body is formed by injection molding.

### SUMMERY OF THE INVENTION

According to an aspect of the present invention, there is provided, a method for manufacturing a light guide body, including the step of forming roughness Ra of a surface of the light guide body to equal to/less than 1.0 μm, and step heights on the surface to equal to/less than 10 μm by means of injection molding.

With the present invention, light leakage can be prevented reliably even when the light guide body is formed by injection molding.

Other aspects, features and advantages of the present invention will become apparent upon reading the following specification and claims when taken in conjunction with the accompanying drawings.

### BRIEF DESCRIPTION OF THE DRAWINGS

For more complete understanding of the present invention and the advantages hereof, reference is now made to the following description taken in conjunction with the accompanying drawings wherein:

FIG. 1 is a perspective view of an optical sheet bus according to an embodiment of the present invention;

FIG. 2 is a plan view of the optical sheet bus;

FIG. 3 is a perspective view showing an injection molding die for forming an optical sheet bus;

FIG. 4A is a sectional view showing an inside of the injection mold;

FIG. 4B is a main part enlarged sectional view showing details of a shaping recess;

FIG. 5 is an exploded sectional view showing details of a fixed side ejection mechanism;

FIG. 6 is a sectional view showing a state where a movable molding die is moved away from a fixed molding die after molding an optical sheet bus;

FIG. 7A is a sectional view showing a state where material is injected to the space between the molding dies;

FIG. 7B is a sectional view showing a state where ejection pins are pressing a completed optical sheet buss to the movable mold side while removing the movable molding die away from the fixed molding die;

FIG. 8 is a sectional view showing a state where a movable side ejection mechanism has pushed an optical sheet bus out of the molding die;

FIG. 9A is a sectional view showing a state where light travels when light is irradiated from a rear side tapered portion of the optical sheet bus;

FIG. 9B is a sectional view showing a state where light travels when light is irradiated from a front side tapered portion of the optical sheet bus;

FIG. 10A is a plan view showing a case where light is passed to a conventional optical sheet bus from one of a plurality of optical fibers to the other side;

FIG. 10B is a view from the Z arrow of FIG. 10A; and

FIG. 10C is a plan view showing a case where light is passed to a conventional optical sheet bus in a direction opposite to that of FIG. 10A.

### DETAILED DESCRIPTION OF THE EXEMPLARY EMBODIMENTS OF THE INVENTION

The following description will explain a detail embodiment of the present invention with reference to the drawings arbitrarily. This embodiment is explained by an example of a so-called optical sheet bus formed in a sheet-shape, that is, in a typical form of a light guide body.

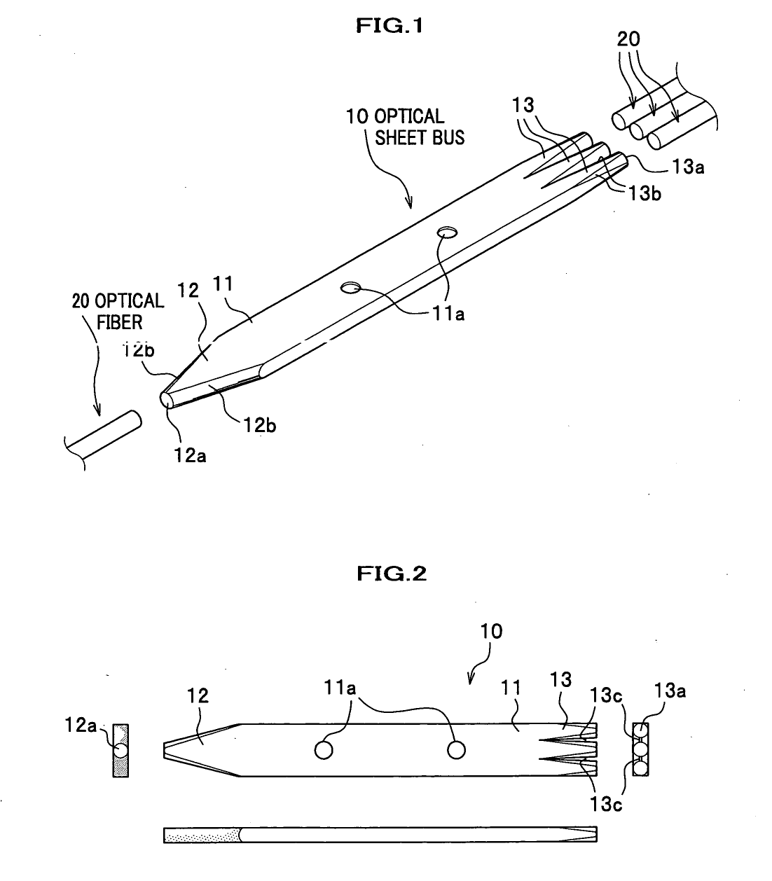

As shown in FIGS. 1 and 2, an optical sheet bus (light guide body) 10 is formed in a lamellar shape, and has a structure in which a single optical fiber 20 is joined to one end side thereof. In addition, three optical fibers 20 are joined to the other end side thereof. It should be noted that the one end side of the optical sheet bus 10 will be referred to as a “front side” and the other end side will be referred to as a “rear side” in the following description for the sake of convenience.

The optical sheet bus 10 is mainly composed of: a rectangular main body 11; a front side tapered portion 12 formed integrally at the front side of the main body 11; and three rear side tapered portions 13 formed integrally at the rear side of the main body 11.

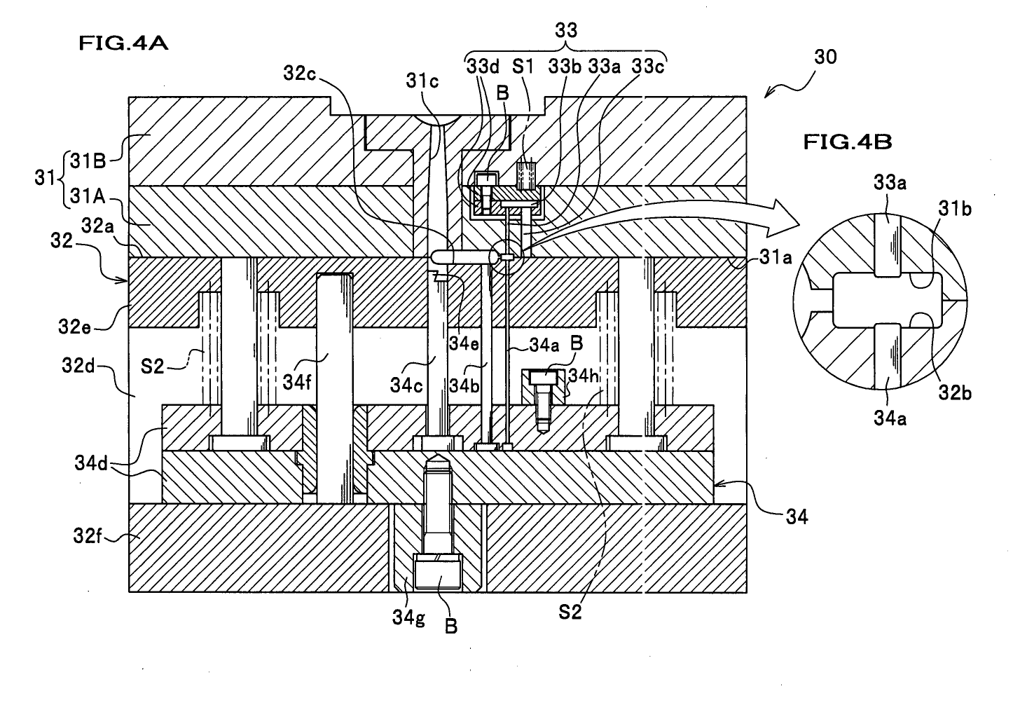

Both sides of the main body 11 are provided with pin depressions 11a. These depressions are formed due to transfer of step heights between shaping recesses 31b and 32b (of molds 31 and 32) and ejection pins 33a and 34a (of ejection mechanisms 33 and 34 provided at an injection molding die 30) (see FIG. 4). It should be noted that the step heights made by the pin depressions 11a are 10 μm or less. Moreover, the optical sheet bus 10 is formed so that the surface roughness Ra thereof is 1.0 μm or less.

The front side tapered portion 12 is shaped so that the width of the main body 11 becomes narrower gradually toward the front side and is formed so that a point surface 12a thereof has substantially the same diameter as that of the optical fiber 20. It should be noted that the angle of this front side tapered portion 12 on a plane view (angle between two slant faces 12b) is substantially the same as an angle at which light from the optical fiber 20 joined to the point surface 12a diffuses. Specifically, this front side tapered portion 12 seems to be shaped by cutting a portion, through which light does not pass, off a conventional rectangular optical sheet bus. In this case, the angle of the front side tapered portion 12 is preferably 3° to 30°.

A rear side tapered portion 13 is provided for each of the three optical fibers 20 joined to the rear side of the optical sheet bus 10, and is shaped by dividing the rear end portion of the main body 11 into three parts and making the width of each divided part become narrower gradually toward the rear side. Moreover, the rear side tapered portion 13 is formed to meet the following two conditions. First, the point surface 13a thereof has substantially the same diameter as that of the optical fiber 20. Second, the angle thereof on a plane view (angle between two slant faces 13b) is smaller than an angle at which light from the optical fiber 20 joined to the point surface 13a diffuses. Furthermore, each rear side tapered portion 13 is reinforced by a reinforcing portion 13c which is formed to connect two adjacent rear side tapered portions 13 to each other. It should be noted that the angle of the rear side tapered portion 13 is preferably 3° to 30°.

Moreover, examples of material of the optical sheet bus 10 include Polymethylmethacrylate (PMMA). In addition, a light-scattering body for causing a scattering effect of light may be mixed in an optical sheet bus made of PMMA as described in, for example, Japanese Unexamined Patent Application Publication No. 10-123350. The scattering effect by such a light-scattering body enables the shortening of the length of light in the traveling direction in the optical sheet bus 10. In one example of such a light-scattering body, Polystyrene (PS) of which refractivity differs from that of PMMA is used.

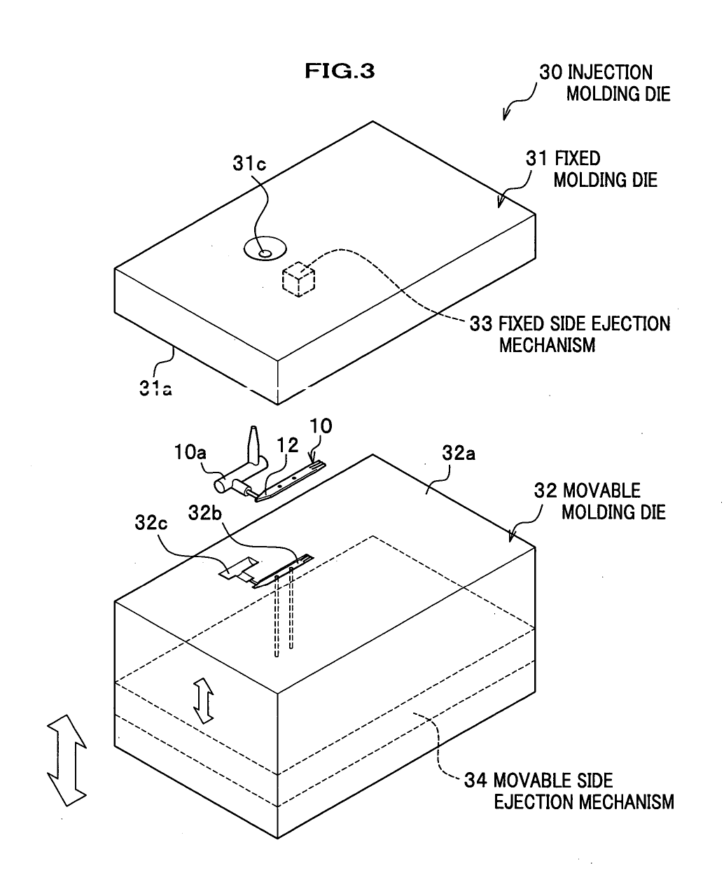

The following describes an injection molding die 30 for manufacturing the optical sheet bus 10 described above with reference to FIG. 3.

As shown in FIG. 3, the injection molding die 30 includes, as main components, a fixed molding die 31, a movable molding die 32 constructed to be freely movable with respect to the fixed molding die 31, a fixed side ejection mechanism 33 provided in the fixed molding die 31, and a movable side ejection mechanism 34 provided in the movable molding die 32.

Mating surfaces 31a and 32a of the fixed molding die 31 and the movable molding die 32 are provided with shaping recesses 31b and 32b (for the shaping recess 31b, see FIG. 4B). They have the form of the upper half part (one part) and the lower half part (the other part) of the optical sheet bus 10, respectively. Moreover, the fixed molding die 31 is provided with a sprue 31c for guiding molten resin (molten material) injected from an injection unit (not illustrated) to a runner formed portion 32c, and the mating surfaces 31a and 32a are provided with the runner formed portion 32c (for details of the sprue 31c, see FIG. 4A) for connecting the shaping recesses 31b and 32b with the sprue 31c.

As shown in FIG. 4A, the fixed side ejection mechanism 33 is mainly composed of: two ejection pins 33a (only the front one is illustrated); a synchronizing pin 33c connected integrally with these ejection pins 33a via a mounting plate 33b; two retainer plates 33d fastened by a bolt B with the mounting plate 33b being sandwiched therebetween in the vertical direction; and a spring S1 for keeping pressing the retainer plates 33d to the movable molding die 32 side.

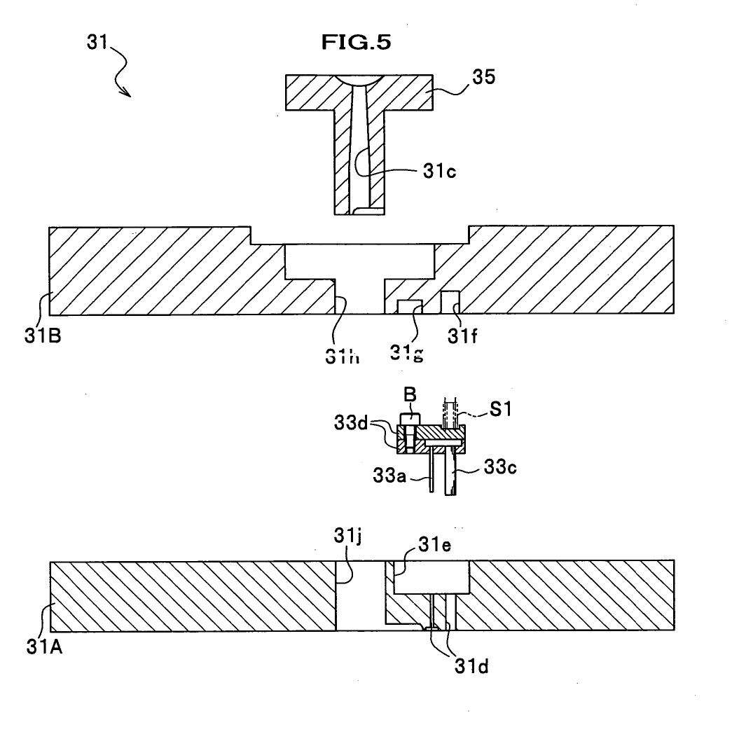

It should be noted that the fixed molding die 31 is divided into an upper part and a lower part, as shown in FIG. 5, and a lower side fixed molding die 31A constituting the lower half part is provided with: engagement pores 31d to be engaged with the ejection pins 33a and the synchronizing pin 33c so as to be freely slidable; and a holding recess 31e to be engaged with two retainer plates 33d fastened by the bolt B so as to be freely slidable. Moreover, an upper side fixed molding die 31B constituting the upper half part of the fixed molding die 31 is provided with: a retainer recess 31f for retaining the spring S1 in a contracted state; and a relief hole 31g for holding the head of the bolt B. In this case, the stroke amount of the retainer plates 33d depends on the vertical relation between the bottom face of the holding recess 31e (of the lower side fixed molding die 31A) and the lower face of the upper side (being fixed molding die 31B). Furthermore, the upper side fixed molding die 31B and the lower side fixed molding die 31A are provided with fitting pores 31h and 31j for attaching a sprue bush 35 having the sprue 31c formed therein.

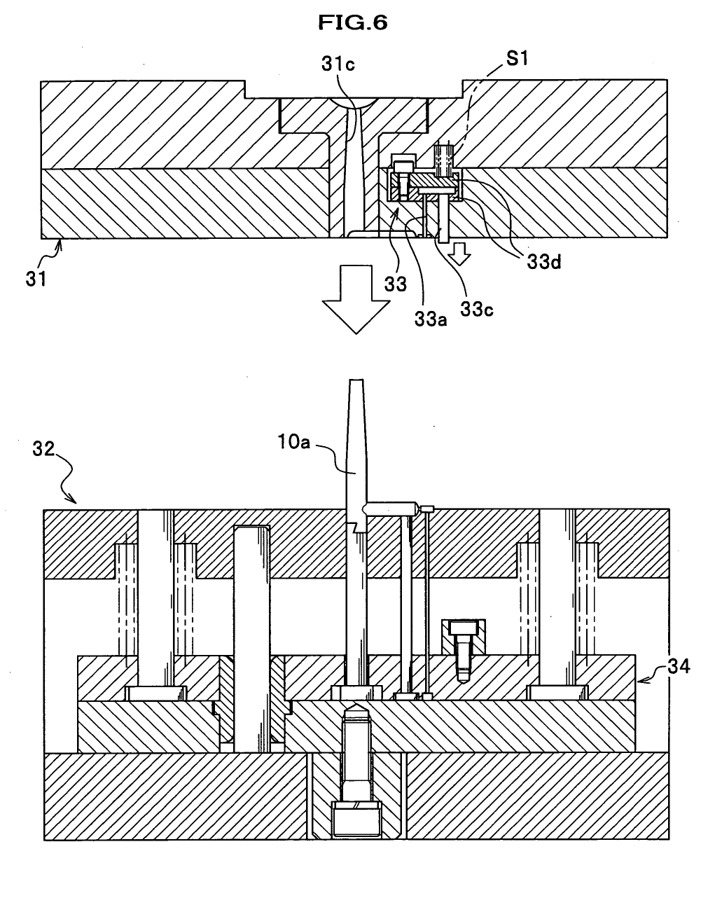

In the fixed side ejection mechanism 33 constructed as described above, while the movable molding die 32 is spaced from the fixed molding die 31 as shown in FIG. 6, the retainer plates 33d are pushed downward by the spring S1. This allows the ejection pins 33a and the synchronizing pin 33c to be ejected downward by a predetermined amount. On the other hand, while the fixed molding die 31 and the movable molding die 32 mate to each other as shown in FIGS. 4A and 4B, the synchronizing pin 33c is pushed by the mating surface 32a of the movable molding die 32 to be flush with the mating surface 31a. Further, the ejection pins 33a move to be substantially flush with the surface of the shaping recess 31b. Actually, the position of the ejection pins 33a is ejected downward slightly. Specifically, the ejection pins 33a and the synchronizing pin 33c are constructed to be freely ejected, respectively, from the form-surfaces of the shaping recess 31b of the fixed molding die 31 and from the mating surface 31a.

As shown in FIG. 4A, the movable side ejection mechanism 34 has: two ejection pins 34a (only the front one is illustrated); two pushing pins 34b and 34c for pushing the runner 10a (see FIG. 3); and two retainer plates 34d for retaining the ejection pins 34a and the pushing pins 34b and 34c integrally. It should be noted that the tip of the pushing pin 34c, which is provided below the sprue 31c extending in the vertical direction, is provided with an engagement claw portion 34e for drawing the molded runner 10a in relation to the movement of the movable molding die 32. Concretely, this engagement claw portion 34e is constructed to get caught on the molded runner 10a by forming an upper step surface portion constituting step heights in an overhung form.

Moreover, the movable side ejection mechanism 34 has: a guide bar 34f which is fixed on the movable molding die 32 to support the retainer plates 34d in a slidable fashion; and a spring S2 for keeping pressing the retainer plates 34d in the direction away from the fixed molding die 31 side. A protrusion portion 34g to be pushed by a pushing unit (not illustrated) is fastened with a bolt B at a substantially center portion of the lower retainer plate 34d of the two retainer plates 34d. Furthermore, a stopper 34h for blocking the retainer plate 34d from moving upward by more than a predetermined amount is fastened at a proper place of the upper retainer plate 34d by a bolt B.

It should be noted that the movable molding die 32 has a die plate 32e and a movable side mounting plate 32f which are connected by a spacer block 32d illustrated at the back of the figure, and the protrusion amount of the ejection pins 34a and the pushing pins 34b and 34c depends on the die plate 32e, the movable side mounting plate 32f, and the lower face of the retainer plate 34d and the upper face of the stopper 34h.

The following describes a manufacturing method for the optical sheet bus 10 by the injection molding die 30 according to the embodiment.

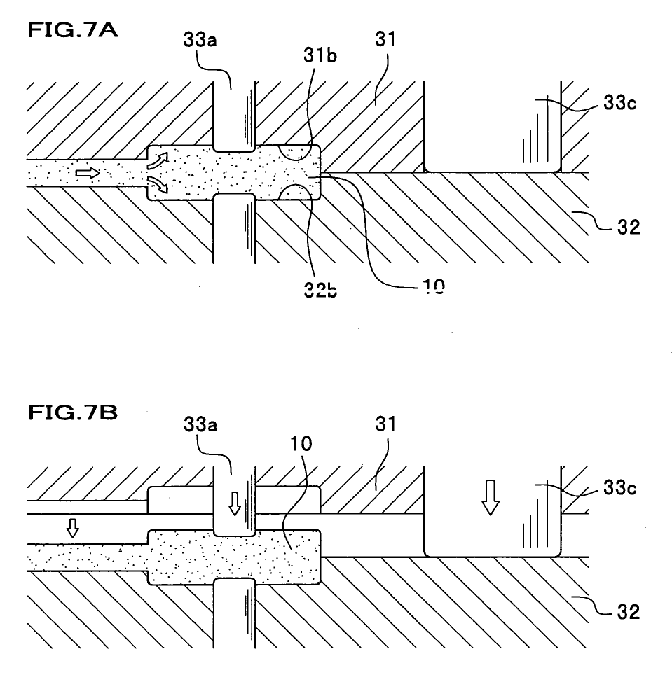

First, an injection unit (not illustrated) is set at the upper end portion of the sprue 31c of the fixed molding die 31 while the fixed molding die 31 and the movable molding die 32 mate to each other as shown in FIG. 4A. Then, when molten resin is injected from the injection unit to the sprue 31c, the injected molten resin runs through the sprue 31c and the runner formed portion 32c and is supplied into a space (cavity) formed at the shaping recesses 31b and 32b as shown in FIG. 7A.

After the molten resin is supplied into the shaping recesses 31b and 32b, an optical sheet bus 10 is molded by cooling the injection molding die 30 to thereby harden the resin. Next, when the movable molding die 32 is moved away from the fixed molding die 31 in order to remove the optical sheet bus 10 from the injection molding die 30, the synchronizing pin 33c supported by the movable molding die 32 moves downward in conjunction with the movable molding die 32 as shown in FIG. 7B. As a result, the ejection pins 33a also eject the optical sheet bus 10 to the movable molding die 32 side at a speed in sync with the movement speed of the synchronizing pin 33c and the movable molding die 32. Specifically, the optical sheet bus 10 moves in conjunction with the movable molding die 32 while the optical sheet bus 10 is retained in the movable molding die 32. Accordingly, it is possible to press the optical sheet bus 10 to the movable molding die 32 side reliably when the molding dies are separated from each other.

It should be noted that the optical sheet bus 10 including the runner 10a is pressed to the movable molding die 32 in a balanced manner during mold opening when the molding dies are separated. This is because the runner 10a (see FIG. 3) is caught on the engagement claw portion 34e, which is formed at the pushing pin 34c on the movable molding die 32 side shown in FIG. 4A, in addition to ejection described above of the optical sheet bus 10 by the ejection pins 33a, so as to move in conjunction with the movable molding die 32.

After the movable molding die 32 is moved downward until the upper end of the runner 10a (concretely, a portion formed of the sprue 31c) comes out of the fixed molding die 31 as shown in FIG. 6, the protrusion portion 34g is pushed up by a pushing unit (not illustrated), so that the optical sheet bus 10 and the runner 10a are ejected outward from the movable molding die 32 as shown in FIG. 8. It should be noted that the optical sheet bus 10 and the runner 10a ejected as described above can be taken out by a robot hand (not illustrated) or other similar tools, along an inclined plane of the engagement claw portion 34e of the pushing pin 34c.

The following describes a surface finish process of the optical sheet bus 10 taken out of the injection molding die 30 as described above.

Since the runner 10a is formed integrally at the front side tapered portion 12 of the optical sheet bus 10 taken out of the injection molding die 30 as shown in FIG. 3, the first operation to be performed is to separate the runner 10a from the optical sheet bus 10 with a nipper or other tools. It should be noted that a portion which remains on the optical sheet bus 10 side after this operation is cut off by a cutting process with a cutter or a grinding process with a grind stone until a surface which is substantially flush with the slant face 12b (see FIG. 1) of the front side tapered portion 12 is obtained. After such a cutting process, the cut-off portion is formed by a lapping (loose grain) process, so that step heights of the cut-off portion are 10 μm or less and the surface roughness Ra thereof is 1.0 μm or less.

Similarly, the pin depressions 11a formed on both sides of the optical sheet bus 10 shown in FIG. 1 are formed so that the step heights thereof are 10 μm or less and the surface roughness Ra thereof is 1.0 μm or less. It should be noted that the other portion, e.g. the slant faces 13b of the rear side tapered portions 13, are formed so that the surface roughness Ra thereof stays 1.0 μm or less, since the shaping recesses 31b and 32b of the molds 31 and 32 are formed to have a smooth surface.

The following describes the effect of the optical sheet bus 10 which is molded in the method described above.

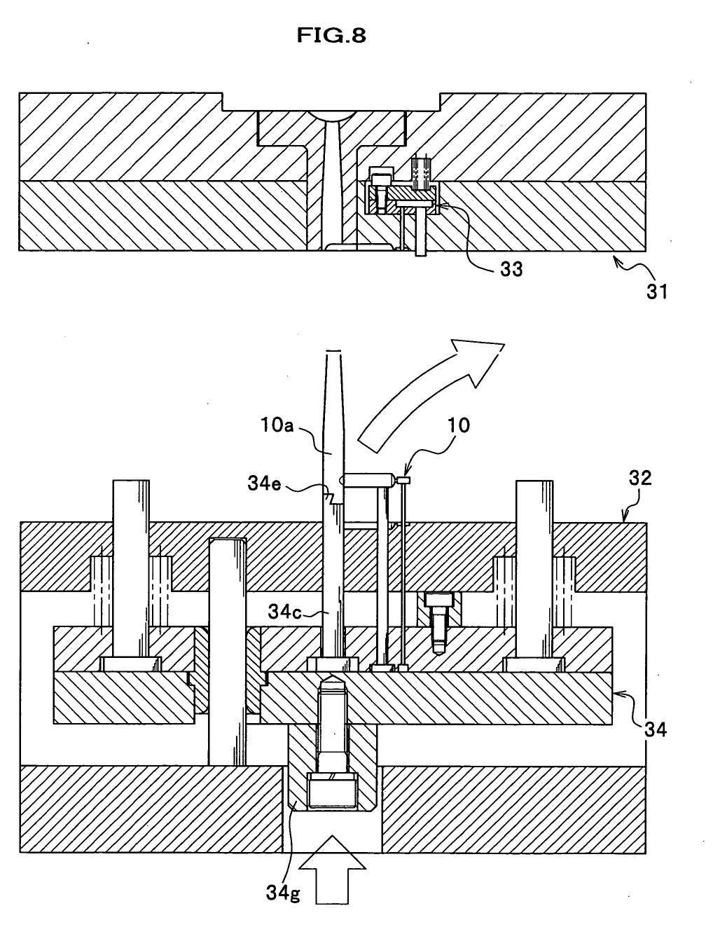

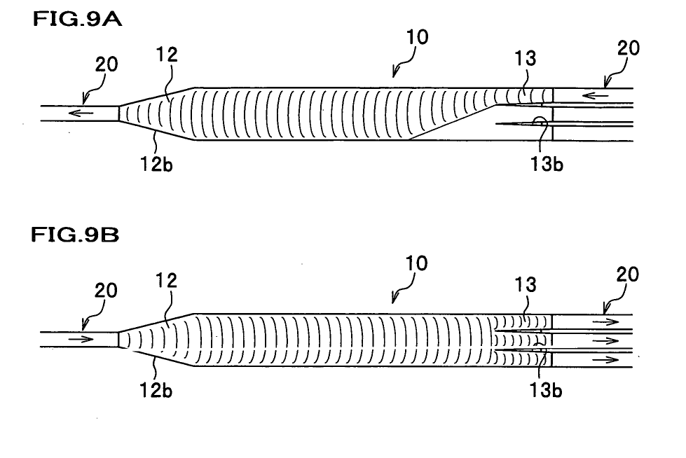

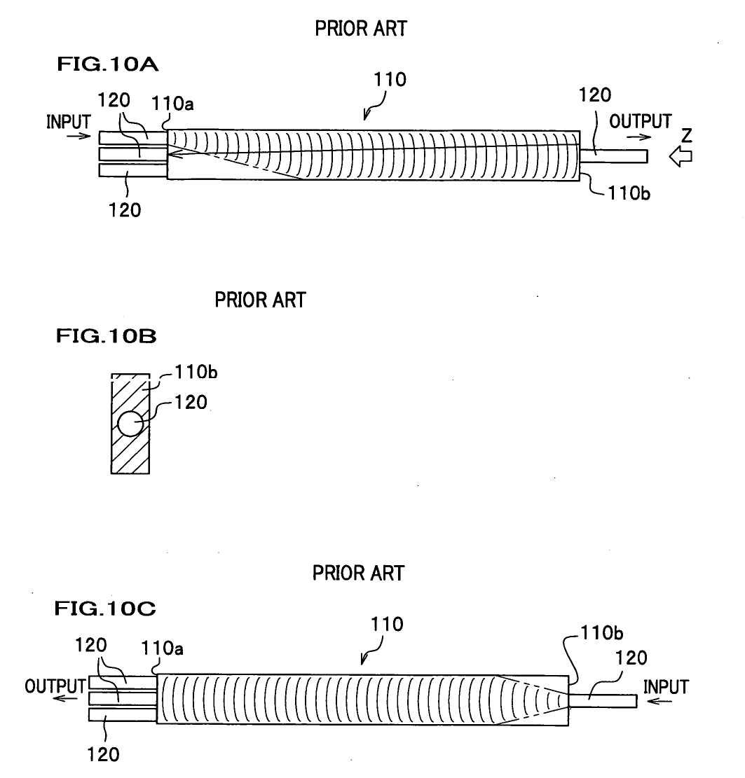

When light is sent from one of the three optical fibers 20 provided on the rear side of the optical sheet bus 10 into the optical sheet bus 10 as shown in FIG. 9A, the light travels through the optical sheet bus 10 to the front side while diffusing. When the light arrives at the inside of the front side tapered portion 12, a part of light which is to be diffused by the slant face 12b of the front side tapered portion 12 is arbitrarily reflected and collected to the front side optical fiber 20, so that the quantity of light transmitted into the optical fiber 20 increases.

On the other hand, when light is sent from the single optical fiber 20 provided at the front side of the optical sheet bus 10 into the optical sheet bus 10 as shown in FIG. 9B, the light travels to the rear side while diffusing along the slant face 12b of the front side tapered portion 12. When the light arrives at the inside of the three rear side tapered portions 13, a part of light which is to be diffused by the slant face 13b of each rear side tapered portion 13 is arbitrarily reflected and collected to each rear side optical fiber 20 side, so that the amount of light transmitted into each optical fiber 20 increases.

As described above, the following effects can be achieved in this embodiment.

Light leakage can be prevented reliably, because the optical sheet bus 10 is formed such that the surface roughness Ra is 1.0 μm or less and the step heights formed on the surface is smaller than or equal to 10 μm.

Even a sheet-shaped optical sheet bus 10 having a simple form can be taken out of the movable molding die 32 preferably, because the fixed side ejection mechanism 33 can press the optical sheet bus 10 to the movable molding die 32 side reliably when the molding dies are separated.

Light can be transmitted efficiently since the tapered portions 12 and 13 can collect a great amount of light into the optical fiber 20.

Wasted portions can be eliminated and weight savings can be realized, because the tapered portions 12 and 13 are shaped by cutting a portion, through which light does not pass, off a conventional rectangular optical sheet bus.

The present invention is not limited to the above embodiment and may be implemented in various manners.

Although the mold surface for molding the optical sheet bus 10 is finished by a lapping process and the ejection pins 33a are finished at a high degree of accuracy to have a height on an order of micrometer (μm) in this embodiment, the present invention is not limited to this, and an optical sheet bus 10 which has been molded in the injection molding die 30 may be dipped in a paint, solvent or molten resin, so that step heights formed on the surface thereof are 10 μm or less and the surface roughness Ra thereof is 1.0 μm or less.

The movement speed of the ejection pins 33a and the movable molding die 32 in this embodiment is synchronized mechanically by moving the synchronizing pin 33c in a constant contact with the movable molding die 32. However, the present invention is not limited to this and another drive unit, for example, may be provided for retracting the ejection pins 33a and the movement speed of the ejection pins 33a by the drive unit may be electrically synchronized with the movement speed of the movable molding die 32.

Although this embodiment is constructed to move the movable side ejection pins 34a and the like with respect to the movable molding die 32 by pushing the protrusion portion 34g with a pushing unit (not illustrated), the present invention is not limited to this. For example, an embodiment may be constructed to move the movable side ejection pins 34a and the like with respect to the movable molding die 32 by providing a locking portion for locking the protrusion portion 34g at a proper place of a path along which the movable molding die 32 moves. Specifically, with this structure, the protrusion portion 34g is locked by the locking portion at a predetermined position as the movable molding die 32 is moved downward, and then, the ejection pins 34a and the like which are supported by the locking portion to stay in a predetermined position are moved relatively upward with respect to the movable molding die 32 as the movable molding die 32 is further moved downward.

Although a sheet-shaped light guide body (optical sheet bus 10) is employed in this embodiment as a physical object to be molded, the present invention is not limited to this and, for example, a rectangular or cylindrical light guide body may be a physical object to be molded.

The injection molding die 30 of this embodiment is opened or closed in the vertical direction. However, the present invention is not limited to this, and may be opened or closed in the horizontal direction instead.

From the aforementioned explanation, those skilled in the art ascertain the essential characteristics of the present invention and can make the various modifications and variations to the present invention to adapt it to various usages and conditions without departing from the spirit and scope of the claims.

1. A method for manufacturing a light guide body, comprising:
forming roughness Ra of a surface of the light guide body to equal to/less than 1.0 μm, and step heights on the surface to equal to/less than 10 μm by means of injection molding.

2. The method according to claim 1, further comprising:
forming both ends of the light guide body to tapered shapes having an angle from 3 to 30 degrees.

3. The method according to claim 1, further comprising:
subjecting the surface of the light guide body to a lapping process as a surface finishing process.

4. The method according to claim 1, further comprising:
dipping the light guide body into a paint, solvent or molten resin as a surface finishing process.

5. The method according to claim 1, further comprising:
forming the light guide body to a sheet shape.

6. The method according to claim 1, further comprising:
forming the light guide body to a rectangular shape.

7. The method according to claim 1, further comprising:
forming the light guide body to a cylindrical shape.

8. An injection molding die comprising:
a first molding die having a first cavity; and
a second molding die having a second cavity;
the first and second cavities facing each other, and forming outer dimensions of a light guide body;
each of the first and second cavities having a surface with roughness Ra of equal to/less than 1.0 μm, and with step heights of equal to/less than 10 μm.

9. The injection molding die according to claim 8,
wherein the surface of each of the first and second cavities is subjected to a lapping process.

10. The injection molding die according to claim 8, further comprising an ejection pin in the first molding die, for ejecting a light guide body from the first molding die toward the second molding die, when the first and second molding dies are separated from each other.

11. The injection molding die according to claim 8,
wherein each of the first and second cavities has tapered ends with an angle from 3 to 30 degrees.

12. The injection molding die according to claim 8,
wherein each of the first and second cavities has a sheet shape.

13. The injection molding die according to claim 8,
wherein each of the first and second cavities is rectangular in shape.

14. The injection molding die according to claim 8,
wherein each of the first and second cavities is cylindrical in shape.
